(19) United States
(12) Patent Application Publication
(10) Pub. No.: US 2003/0181116 A1
(43) Pub. Date: Sep. 25, 2003

(54) Tactile feedback device

(75) Inventors: Clive R. Van Heerden, Bronx, NY (US); George Marmaropoulos, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/104,929

(22) Filed: Mar. 22, 2002

(51) Int. Cl. D03D 15/08; D03D 17/00; D03D 15/00; B32B 15/14

(52) U.S. Cl. 442/182; 442/228; 442/229; 442/234; 442/238

(57) ABSTRACT

A tactile feedback device includes an elastic body adapted to be worn by a user and a shape memory alloy connected to the elastic body. The application of power causes the shape memory alloy to assume a memory shape that produces tactile feedback to the user. The elastic body may include a woven elastic material and may be embodied in a wrist band. The shape memory alloy may be located in a recess of the elastic body, or may be interwoven in the elastic body.

### FIELD OF THE INVENTION

The present invention relates to a device for providing tactile feedback. More particularly, the present invention relates to a tactile feedback device for providing a perceptible pulse of force to one wearing the device.

### DESCRIPTION OF THE PRIOR ART

Shape memory alloys are known to undergo plastic deformation from a “trained” shape to a “memory” shape when heated. When a shape memory alloy is below its transformation temperature, it exhibits a low yield strength and may be formed into a desired or “trained” shape. When heated above its transformation temperature, the shape memory alloy undergoes a change in crystal structure that causes it to return to its original, “memory” shape. The alloy is capable of exerting a significant amount of force in the face of resistance when returning to its memory shape.

The shape memory alloy material undergoes a reversible change from an austenitic state to a martensitic state at the transformation temperature. If the alloy material is formed to a trained shape while below the martensitic temperature and then heated above the austenitic temperature, the shape memory alloy material will assume the shape existing before the formation, that is, its memory shape.

The alloy may be given a new memory shape by heating the alloy well beyond its transformation temperature to its annealing temperature and constraining the alloy material to the new memory shape for a period of time.

There are many applications that require reading or otherwise perceiving the output of a device. The device output, or feedback, may be visual or audible. Examples of devices for providing feedback include LED's, liquid crystal displays, piezo electric speakers, etc. In certain situations, it would be desirable to have an alternative feedback device. For example, when the visual attention of a user is otherwise occupied, or when the environment is noisy, conventional feedback devices may not be suitable.

As a specific example, wrist watch type devices are currently available for monitoring a persons heart rate. However, a person who is running, participating in other strenuous sports, work, or other activity may find it difficult to read a visual display or listen to an audible indicator of their heart rate.

It would thus be desirable to provide an alternative feedback mechanism in situations where visual or aural observation may be difficult or unacceptable.

### SUMMARY OF THE INVENTION

It is an object of the present invention to provide a device that imparts tactile feedback to a user.

It is another object of the present invention to provide such a tactile feedback device through the use of a memory alloy.

It is still another object of the present invention to provide tactile feedback from the device by applying power to a memory alloy in a controlled pattern.

It is yet another object of the present invention to provide a tactile feedback device that isolates the memory alloy from direct contact with the user.

It is a further object of the present invention to provide a tactile feedback device that provides feedback to the wrist of a user.

These and other objects and advantages of the present invention are achieved by a tactile feedback device that includes an elastic body adapted to be worn by a user and a shape memory alloy connected to the elastic body. In this device, the application of power causes the shape memory alloy to assume a memory shape that produces tactile feedback to the user. The elastic body may include a woven elastic material and may be embodied in a wrist band. The shape memory alloy may be located in a recess of the elastic body, or may be interwoven in the elastic body.

### BRIEF DESCRIPTION OF THE DRAWINGS

The present invention is more fully understood by reference to the following detailed description of a preferred embodiment in combination with the drawings identified below.

FIG. 1 is a perspective view of a tactile feedback device in accordance with a preferred embodiment of the present invention;

FIG. 2 is a cross-section view of the tactile feedback device of FIG. 1;

FIG. 3 is a perspective view of an alternate embodiment of the tactile feedback device of the present invention; and

FIG. 4 is a cross-section view of the tactile feedback device of FIG. 3.

### DETAILED DESCRIPTION OF THE INVENTION

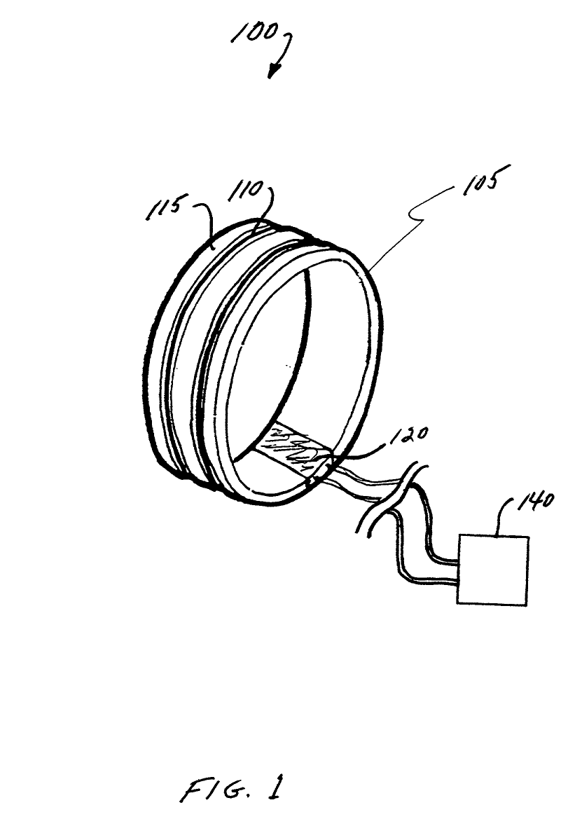

Referring to the drawings and, in particular, FIG. 1, there is shown a tactile feedback device in accordance with a preferred embodiment of the present invention, generally represented by reference numeral 100. Tactile feedback device 100 includes an elastic band 105, one or more memory shape alloy elements in the form of wires 110, and a connection device 120 for supplying power to the memory alloy wires 110.

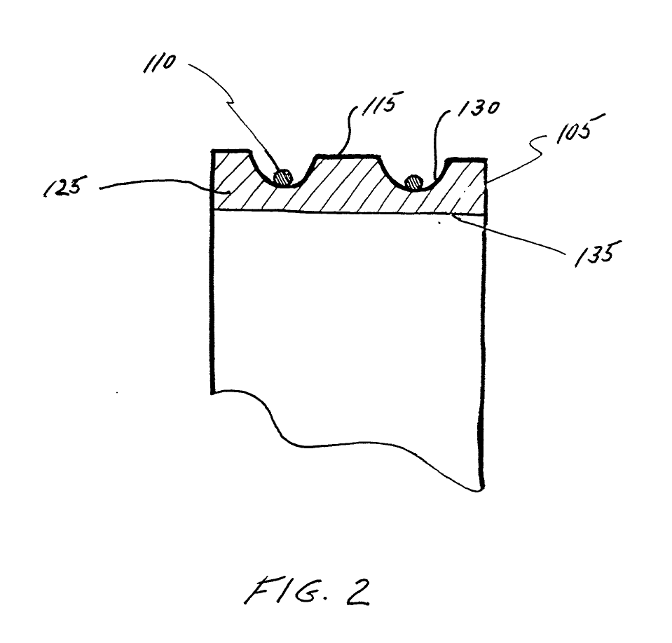

FIG. 2 shows a cross-section view of tactile feedback device 100. Elastic band 105 includes elastic body 125 to which memory alloy wires 110 may be connected. Elastic band 105 may be in the form of a wrist band or even a watch band. Elastic body 125 may be made of a polymer, rubber, or other elastic material. Elastic body 125 includes an outer surface 115 with one or more recesses 130. Recesses 130 are constructed so that memory alloy wires 110 may be located below outer surface 115 in order to avoid direct contact with the user's skin. The open construction of recesses 130 also allows memory alloy wires 110 to cool rapidly when power is removed. Elastic body 125 also has an inner surface 135 that insulates elastic band 105 from the user. Inner surface 135 thus protects the user from heat resulting from powering memory alloy wires 110.

Returning to FIG. 1, connection device 120 may include a connector and a number of conductors for supplying power from a power supply 140 to memory alloy wires 110. Alternatively, connection device 120 may be wired directly from the power supply 140 to the memory alloy wires 110. It should be understood that connection device 120 may include any device suitable for providing an electrical path between power supply 140 and memory alloy wires 110.

Power supply 140 is preferably connected to a device that provides feedback to a user, and the output of power supply 140 is modulated by the device to provide feedback.

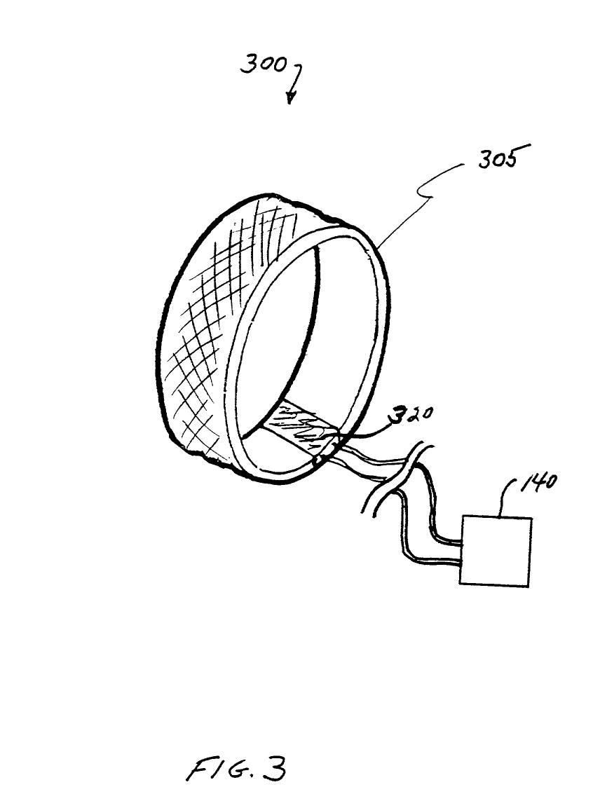

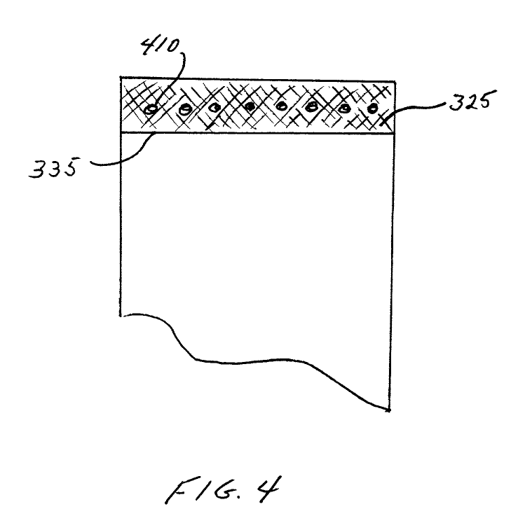

FIG. 3 shows a perspective view of an alternate embodiment of the tactile feedback device generally represented by reference numeral 300. Tactile feedback device 300 includes an elastic band 305, one or more memory shape alloy elements in a form of wires known in the art as “muscle wires” 410 (FIG. 4), and a connection device 320 for supplying power to the muscle wires 410 from power supply 140.

A cross-section view of tactile feedback device 300 is shown in FIG. 4. Elastic band 305 includes elastic body 325 that may be made of a woven elastic material, preferably an elastic fiber. Muscle wires 410 are retained in the elastic body 325 and may be woven together with the elastic fiber. Alternatively, elastic body 325 may include layers of material, and muscle wires 410 may be retained between the layers. Muscle wires 410 are located on or within elastic body 325 to avoid contact with a wearer's skin. The weave of elastic body 325 is constructed to allow muscle wires 410 to quickly cool upon the removal of power. Elastic body 325 is also constructed to insulate muscle wires 410 from the user, and may include an insulating layer 335 to protect the user from heat radiating from muscle wires 410.

Memory alloy wires 110 and muscle wires 410, collectively referred to as memory alloy devices (110, 410), may include any nickel-titanium-based shape memory alloy, or any other material exhibiting a shape memory upon traversing a transition temperature. The application of power to memory alloy devices (110, 410) causes them to increase in temperature and assume their memory shape. Upon removal of power, memory alloy devices (110, 410) cool, and return to their trained shape.

Memory alloy devices (110, 410) are given a suitable memory shape by heating them to their annealing temperature and forming them to a shape that in one embodiment constricts the elastic body (125, 325). Memory alloy devices (110, 410) are then allowed to cool below their transition temperature and are then formed into a trained shape, preferably a circular shape that allows the elastic body (125, 325) to relax and return to its original shape. Memory alloy wires 110 are located in recesses 130, and muscle wires 410 may be woven into or otherwise located in elastic body 325. Memory alloy devices (110, 410) are connected to power supply 140, which in turn may be connected to, or part of, a device for providing feedback that a user desires to perceive.

In a preferred embodiment, the elastic band (105, 305) is worn on the wrist of the user. Modulated power is applied to the memory alloy devices (110, 410) and they alternately contract and relax as they heat and cool, respectively, according to the modulation. The user perceives this contraction and relaxation and information is thus conveyed to the user.

Using the example mentioned above of a person running, the heart rate monitor worn by the user may modulate the power supply 140 causing the memory alloy devices (110, 410) to contract and relax in sequential cycles to convey information. For example, two cycles of contractions and relaxations may signify that the user has a heart rate of 200 beats per minute.

As another example, a distance measuring device may be connected to the power supply 140 that provides modulation corresponding to a distance traveled. In this example, three cycles of contraction and relaxation may signify that a user has traveled three hundred yards.

In another embodiment a rhythm generating device may be connected to the power supply 140 that provides modulation resulting contractions and relaxations having a particular tempo. This may be useful in maintaining a rhythm in running, other sports, or other activity, encouraging better results and performance.

While the invention has been described in the context of shape memory alloy in the form of wires that contract, it should be understood that any form of shape memory alloy may be used that provides tactile feedback. For example, a memory alloy in the form of a rod, oriented axially to a portion of a person's body may be used to provide tactile feedback. In this case, the application of power may cause the rod to elongate and press upon the body of the user.

It should also be understood that the application of power to the memory alloy is not limited to modulation that produces sequential contraction and relaxation cycles but may include modulation that produces any tactile sensation that may be perceived by the user.

The present invention having been thus described with particular reference to the preferred forms thereof, it will be obvious that various changes and modifications may be made therein without departing from the spirit and scope of the present invention as defined herein.

What is claimed is

1. A tactile feedback device comprising:
an elastic body adapted to be worn by a user; and
a shape memory alloy connected to the elastic body, wherein the shape memory alloy assumes a memory shape that produces tactile feedback to the user when power is applied to the device.

2. The tactile feedback device of claim 1, wherein the elastic body comprises a woven elastic material.

3. The tactile feedback device of claim 1, wherein the elastic body is embodied in a wrist band.

4. The tactile feedback device of claim 1, wherein the shape memory alloy is located in a recess of the elastic body.

5. The tactile feedback device of claim 1, wherein the shape memory alloy is interwoven in the elastic body.

6. The tactile feedback device of claim 1, wherein the elastic body has a plurality of layers, and wherein the shape memory alloy is retained between the plurality of layers of the elastic body.

7. The tactile feedback device of claim 1, wherein the shape memory alloy has a shape of a wire.

8. The tactile feedback device of claim 1, wherein the shape memory alloy has a memory shape that constricts the elastic body and a second shape that allows the elastic body to relax.

9. The tactile feedback device of claim 1, further comprising a connection device for providing an electrical path between the shape memory alloy and a power supply.

10. A method of providing tactile feedback comprising:
providing a shape memory alloy coupled to an elastic body adapted to be worn by a user; and
applying power to the shape memory alloy causing the shape memory alloy to assume a memory shape that produces tactile feedback to the user.

11. The method of claim 10, wherein the elastic body comprises a woven elastic material.

12. The method of claim 10, wherein the elastic body is embodied in a wrist band.

13. The method of claim 10, wherein the shape memory alloy is located in a recess of the elastic body.

14. The method of claim 10, wherein the shape memory alloy is interwoven in the elastic body.

15. The method of claim 10, wherein the elastic body has a plurality of layers, and wherein the shape memory alloy is retained between the plurality of layers of the elastic body.

16. The method of claim 10, wherein the shape memory alloy has a shape of a wire.

17. The method of claim 10, wherein the shape memory alloy has a memory shape that constricts the elastic body and a second shape that allows the elastic body to relax.

18. The method of claim 10, further comprising a connection device for providing an electrical path between the shape memory alloy and a power supply.
